(19) United States
(12) Patent Application Publication
(10) Pub. No.: US 2013/0092189 A1
(43) Pub. Date: Apr. 18, 2013

(54) APPLIANCE WITH TURBIDITY SENSOR CALIBRATION

(71) Applicant: Jing Shen Tang, Louisville, KY (US)

(72) Inventor: Jing Shen Tang, Louisville, KY (US)

(73) Assignee: GENERAL ELECTRIC COMPANY, Schenectady, NY (US)

(21) Appl. No.: 13/272,588

(22) Filed: Oct. 13, 2011

(51) Int. Cl. B08B 3/00

(52) U.S. Cl. 134/18; 134/56 R

(57) ABSTRACT

An appliance is disclosed for improving the accuracy of turbidity measurements. In an exemplary embodiment, the appliance includes a turbidity sensor and at least one processing device in communication with the turbidity sensor. The at least one processing device is configured to conduct a measurement of turbidity with the turbidity sensor exposed to air instead of water so as to provide a reference output from the turbidity sensor exposed to air; measure a turbidity of a fluid in the appliance during operation of the appliance with the turbidity sensor exposed to the fluid so as to provide a measurement output from the turbidity sensor exposed to the fluid; determine a temperature of the fluid; and apply an offset to the measurement output in order to provide an adjusted output, the adjusted output compensating for the difference in output of the turbidity sensor in water instead of air and for the temperature of the fluid.

### FIELD OF THE INVENTION

The subject matter of the present disclosure relates generally to the calibration of a turbidity sensor in an appliance such as a dishwasher.

### BACKGROUND OF THE INVENTION

Consumer appliances such as dishwashers or washing machines have been proposed wherein items are placed in a wash chamber that is filled and emptied according to desired wash sequences. With continued pressure on natural resources, appliance manufacturers have focused on efficiency in implementing new designs. Accordingly, appliance manufacturers have scrutinized the amount of electricity, the amount of detergent, and the amount of water used by their appliances because these are all important factors in providing efficient and environmentally sensitive machines.

One approach for improving efficiency has involved measuring water quality in a given cycle of an appliance and using the measurements as a factor in determining the cycle's duration. For example, the turbidity of water being cycled through a dishwasher can be measured and used to optimize the cycle in order to only use as much energy and water as is needed to clean a given load. The amount of energy and water could vary, in some cases, depending on the type of items being washed, the amount of items being washed, and the cleanliness of the items being washed by the appliance. In some cases, for example, users will rinse off dishes in a sink before placing them in a dishwasher. Doing so can reduce the need for pre-washing by the appliance to remove debris.

Accordingly, measuring the turbidity of water in an appliance can be used to increase the appliance's efficiency. However, in order to realize an efficiency increase, an appliance's turbidity measuring device should gather accurate turbidity measurements. Specifically, the turbidity measuring device should be able to measure the turbidity of a fluid relative to the turbidity of the relatively clean water supplied to the appliance—i.e. the sensor should be calibrated relative to this clean supply water. In one conventional approach, a turbidity sensor measures the turbidity of water during the appliance's final rinse cycle in order to calibrate the turbidity sensor. This approach is based upon the assumption that the water of the final rinse cycle is, in fact, substantially clean. However, the water of the final rinse cycle may not be substantially clean, and, thus, inaccurate turbidity measurements may result from calibrating the turbidity sensor based on such measurements taken during the final rinse cycle.

Accordingly, a new method for operating turbidity sensing devices is needed in order to assist in obtaining accurate turbidity measurements.

### BRIEF DESCRIPTION OF THE INVENTION

Aspects and advantages of the invention will be set forth in part in the following description, or may be obvious from the description, or may be learned through practice of the invention.

In one embodiment, the present subject matter discloses an appliance that includes a turbidity sensor and at least one processing device in communication with the turbidity sensor. The at least one processing device is configured to conduct a measurement of turbidity with the turbidity sensor exposed to air instead of water so as to provide a reference output from the turbidity sensor exposed to air, measure a turbidity of a fluid in the appliance during operation of the appliance with the turbidity sensor exposed to the fluid so as to provide a measurement output from the turbidity sensor exposed to the fluid, determine a temperature of the fluid, and apply an offset to the measurement output so as to provide an adjusted output, the offset compensating for the difference in output of the turbidity sensor in water instead of air and for the temperature of the fluid.

In another embodiment, the present subject matter discloses a method of operating a turbidity sensor reading for an appliance that includes the steps of conducting a measurement of turbidity with a turbidity sensor exposed to air instead of water so as to provide a reference output from the turbidity sensor exposed to air, measuring a turbidity of a fluid in the appliance during operation of the appliance with the turbidity sensor exposed to the fluid so as to provide a measurement output from the turbidity sensor exposed to the fluid, determining a temperature of the fluid, and applying an offset to the measurement output from said step of measuring in order to provide an adjusted output, the offset compensating for the difference in output of the turbidity sensor in water instead of air and for the temperature of the fluid provided by said step of determining.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side partial cut-away view of an exemplary dishwasher that may be configured in accordance with aspects of the invention;

FIG. 2 is a schematic view of one possible fluid system the dishwasher of FIG. 1;

FIG. 3 provides a block diagram of an exemplary control system according to an exemplary embodiment of the present disclosure;

FIG. 4 provides a flow chart of a method for operating a turbidity sensor according to an exemplary embodiment of the present disclosure.

FIG. 5 provides a flow chart of a method for calibrating a turbidity sensor according to an exemplary embodiment of the present disclosure.

FIG. 6 provides a flow chart of a method for updating a turbidity sensor calibration according to an exemplary embodiment of the present disclosure.

FIG. 7 provides a graphical representation of a series of turbidity sensor readings of substantially clean water and air at various temperatures according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

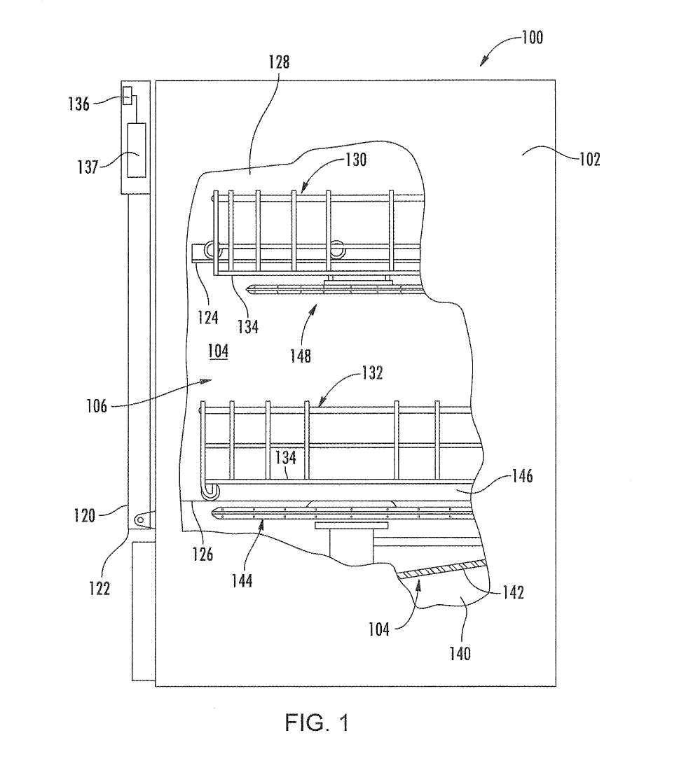

FIG. 1 depicts an exemplary domestic dishwasher 100 that may be configured in accordance with aspects of the disclosure, although it should be understood that the method disclosed herein is not limited to use with dishwashers and may be used with other appliances such as e.g., washing machines.

Briefly, the dishwasher 100 includes a cabinet 102 having a tub 104 therein that defines a wash chamber 106. The tub 104 includes a front opening (not shown in FIG. 1) and a door 120 hinged at its bottom 122 for movement between a normally closed vertical position wherein the wash chamber 106 is sealed shut for washing operation, and a horizontal open position for loading and unloading of dishwasher contents. Upper and lower guide rails 124, 126 are mounted on tub side walls 128 and accommodate upper and lower roller-equipped rack assemblies 130, 132, respectively.

A lower spray-arm-assembly 200 is rotatably mounted within a lower region 146 of the wash chamber 106 and above tub sump portion 142 so as to rotate in relatively close proximity to the lower rack assembly 132. A mid-level spray-arm assembly 148 is located in an upper region of the wash chamber 106 and is located in close proximity to the upper rack 130 and at a sufficient height above lower rack 132 to accommodate larger items, such as a dish or platter. In a further embodiment, an upper spray assembly may be located above the upper rack assembly 130 at a sufficient height to accommodate taller items in the upper rack assembly 130.

The lower and mid-level spray-arm assemblies 144, 148 and the upper spray arm assembly are fed by a fluid circulation assembly for circulating water and dishwasher fluid in the tub 104. The fluid circulation assembly may be located in a machinery compartment 140 located below the bottom sump portion 142 of the tub 104, as generally recognized in the art.

Operation of the dishwasher 100 is regulated by a controller 137 which is operatively coupled to a user interface panel or input 136 for user manipulation to select dishwasher machine cycles and features. In response to user manipulation of the user interface 136, the controller 137 operates the various components of the dish washer 100 and executes selected machine cycles and features. The controller may include a memory and microprocessor, CPU or the like, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area of door 120 as shown. In such an embodiment, input/output (“I/O”) signals may be routed between the control system and various operational components of dishwasher 100 such as the turbidity sensor 250 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

Again, it should be appreciated that the method disclosed herein is not limited to any particular style, model, or other configuration of dishwasher, and that the embodiment depicted in FIG. 1 is for illustrative purposes only, and, again, it should be understood that the method disclosed herein is not limited to use with dishwashing appliances and, instead, may be used with other appliances as well.

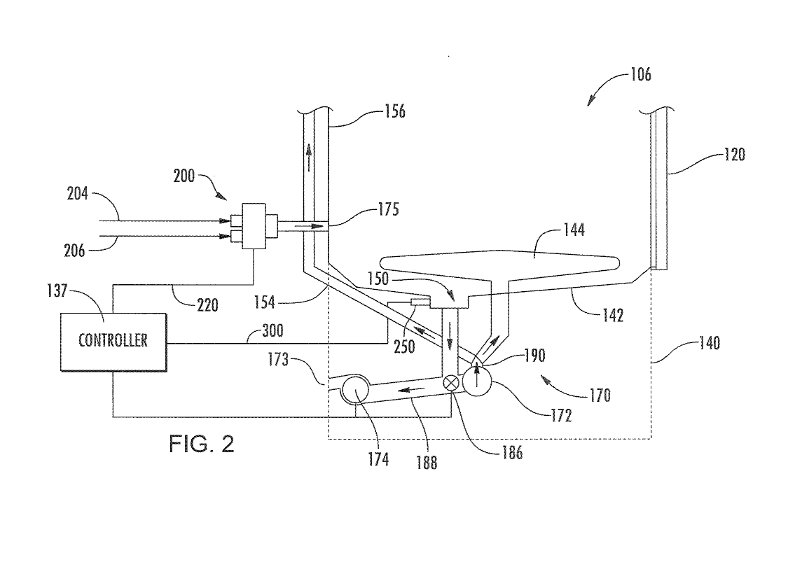

FIG. 2 schematically illustrates an embodiment of a fluid circulation assembly 170 configured below the wash chamber 106. Although one embodiment of a fluid circulation assembly that is operable to perform in accordance with aspects of the disclosure is shown, it is contemplated that other fluid circulation assembly configurations may similarly be utilized without departing from the spirit and scope of the invention. The fluid circulation assembly 170 includes a circulation pump assembly 172 and a drain pump assembly 174, both in fluid communication with the sump 150. Additionally, the drain pump assembly 174 is in fluid communication with an external drain 173 to discharge used wash liquid. Further, the circulation pump assembly 172 is in fluid communication with lower spray arm assembly 144 and conduit 154 which extends to a back wall 156 of wash chamber 106, and upward along the back wall 156 for feeding wash liquid to the mid-level spray arm assembly 148 (FIG. 1) and an upper spray assembly. This configuration also applies to a drawer-type of dishwasher, as mentioned above.

As wash liquid is pumped through the lower spray arm assembly 144, and further delivered to the mid-level spray arm assembly 148 and the upper spray arm assembly (not shown), washing sprays are generated in the wash chamber 106, and wash liquid collects in the sump 150. The sump 150 may include a cover to prevent larger objects from entering the sump 150, such as a piece of silverware or another dishwasher item that is dropped beneath lower rack 132. A coarse filter and a fine filter (not shown) may be located adjacent the sump 150 to filter wash liquid for sediment and particles of predetermined sizes before flowing into the sump 150. Furthermore, a turbidity sensor 250 may be coupled to the sump 150 and used to sense a level of sediment in the sump 150 and to initiate a sump purge cycle where the contents or a fractional volume of the contents of the sump 150 are discharged when a turbidity level in the sump 150 approaches a predetermined threshold. Thus, an amount of water used by the consumer appliance may be controlled in part by outputs of a turbidity sensor to more efficiently and effectively manage and reduce water use to only that needed, thereby reducing waste and cost. The sump 150 is filled with water through an inlet port 175 which outlets into wash chamber 106, as described in greater detail below.

As shown, a drain valve 186 is established in flow communication with the sump 150 and opens or closes flow communication between the sump 150 and a drain pump inlet 188. The drain pump assembly 174 is in flow communication with the drain pump inlet 188 and may include an electric motor for pumping fluid at the inlet 188 to an external drain system via drain 173. In one embodiment, when the drain pump is energized, a negative pressure is created in the drain pump inlet 188 and the drain valve 186 is opened, allowing fluid in the sump 150 to flow into the drain pump inlet 188 and be discharged from the fluid circulation assembly 170 via the external drain 173. Alternatively, the pump assemblies 172 and 174 may be connected directly to the side or the bottom of the sump 150, and the pump assemblies may each include their own valving replacing the drain valve 186. Other fluid circulation systems are possible as well, drawing fluid from the sump 150 and selectively providing such fluid within the wash chamber 106 or selectively draining such fluid out of the dishwasher 100. A selector valve 190 may be provided to select whether the upper arm 148, lower arm 144, or both receive fluid during circulation.

Referring to FIG. 2, a water supply 200 may be configured with the inlet port 175 for supplying wash liquid to the wash chamber 106. The water supply 200 may provide hot water only, cold water only, or either selectively as desired. As depicted, the water supply 200 has a hot water inlet 204 that receives hot water from an external source, such as a hot water heater and a cold water input 206 that receives cold water from an external source. It should be understood that the term “water supply” is used herein to encompass any manner or combination of valves, lines or tubing, housing, and the like, and may simply comprise a conventional hot or cold water connection.

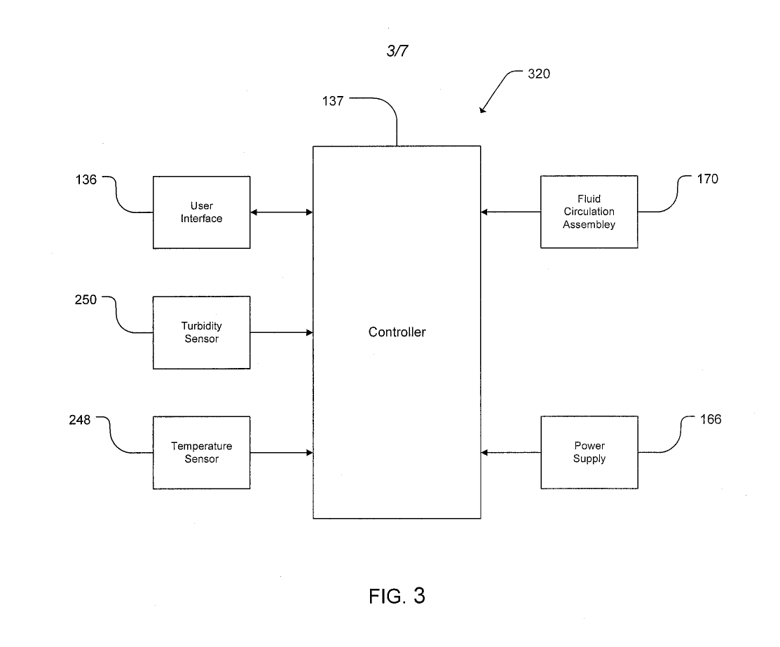

FIG. 3 is a schematic view of a control system 320 of the dishwasher 100 of FIG. 1. The control system 320 includes the controller 137 that controls operation of the dishwasher 100 by directing energy to the various components of the dishwasher 100.

Power to the control system 320 may be supplied to the controller 137 by a power supply 166 configured to be coupled to a power line. Analog to digital and digital to analog converters (not shown) may be coupled to the controller 137 to convert inputs to the controller 137 and to convert executable instructions of the controller 137 in order to generate controller output to dishwasher components. In general, the controller 137 may be configured to operate the various components of the dishwasher 100 in designated cycles familiar to those in the art of dishwashers. More specifically, the controller 137 may be operatively coupled to the fluid circulation assembly 170 and/or any component of the fluid circulation assembly 170 such as the water supply 200, the circulation pump assembly 172, the drain valve 186, and/or the drain pump assembly 174. The controller 137 may be coupled to the fluid circulation assembly 170 according to known methods, whereby, certain functions are performed in response to particular signals from inputs.

The controller 137 may monitor various operational factors of the dishwasher 100 with one or more sensors or transducers. For example, the controller 137 may receive signals from inputs such as the turbidity sensor 250 and/or a temperature sensor 248 (e.g., the temperature sensor 248 may be a thermocouple configured to determine the temperature of the wash chamber 106). Thus, in accordance with aspects of the present disclosure, the controller 137 may receive signals from the turbidity sensor 250 and the temperature sensor 248, and the controller 137 may analyze the signals received from the turbidity sensor 250 and the temperature sensor 248 in order to determine the turbidity of a fluid being exposed to the turbidity sensor 250. The controller 137 may also alter a cycle of the dishwasher based at least in part on signals received from the turbidity sensor 250 and the temperature sensor 248. For example, the controller 137 may adjust a flow of the water supply 200, may adjust a flow through the circulation pump assembly 172, and/or may adjust the drain valve 186 and drain pump assembly 174 in order to being draining the sump 150 if the turbidity of a fluid in the sump 150 based at least in part on signals received from the turbidity sensor 250 and the temperature sensor 248.

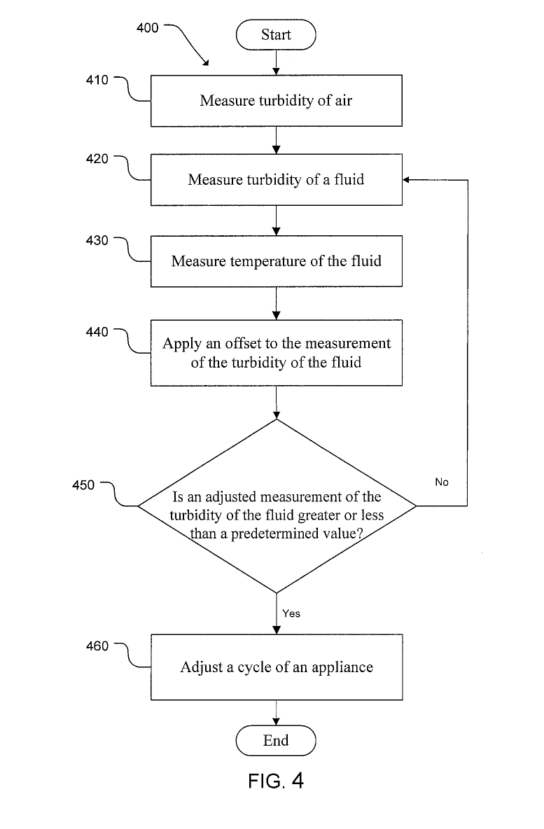

FIG. 4 provides a flow chart of exemplary method steps for operating a turbidity sensor 250. The method 400 may be implemented by the controller 137 of the dishwasher 100 described above. In this exemplary embodiment, in order to obtain more accurate turbidity measurements, the method 400 includes the following steps. Beginning at 410, a measurement of turbidity is conducted with the turbidity sensor 250 exposed to air instead of water so as to provide a reference output from the turbidity sensor 250 exposed to air. The reference output is a signal that corresponds to a turbidity measurement of air. In various embodiments, the signal may be a voltage, current, or any other suitable output.

For step 410, the measurement of turbidity with the turbidity sensor 250 exposed to air may be conducted when the appliance containing the turbidity sensor 250 is not being operated by a user. For example, a controller 137 may determine that the appliance is not being operated by the user (e.g., the control panel has no active command input from the user). When the controller 137 determines that the appliance is not being operated by the user, the controller 137 may conduct the measurement of turbidity with the turbidity sensor 250 exposed to air instead of water at a predetermined interval (e.g., every six, twelve, or twenty-four hours) or a predetermined time (e.g., immediately, thirty minutes, or one hour after the user completes operation of the appliance). In alternative embodiments, the controller 137 may conduct the measurement of turbidity with the turbidity sensor 250 exposed to air instead of water at a time during operation of the appliance when the turbidity sensor 250 is not exposed to a liquid (e.g., during a draining or drying cycle).

At step 420, a measurement of turbidity is conducted with the turbidity sensor 250 exposed to a fluid so as to provide a measurement output. The measurement output is a signal that corresponds to a particular turbidity measurement of the fluid. In various embodiments, the signal may be a voltage, current, or any other suitable output. The controller 137 may measure the turbidity of the fluid when the control panel has an active command input from the user. For example, the controller 137 may measure the turbidity of the fluid during a rinse cycle or a wash cycle of the appliance.

At step 430, a temperature of the fluid is determined. For example, at 430, the controller 137 may determine the temperature of the fluid at about the same time as step 420 is executed. Accordingly, in exemplary embodiments, when the controller 137 receives an input from the turbidity sensor 250 exposed to the fluid, the controller may also receive a signal (e.g., a voltage or current) from a temperature sensor 248 where the signal corresponds to the temperature of the fluid. In alternative embodiments, the controller 137 may receive the signal from the temperature sensor 248 at any suitable time such that the controller 137 receives a measurement representative of the temperature of the fluid exposed to the turbidity sensor 250.

At step 440, an offset may be applied to the measurement output in order to provide an adjusted output. In exemplary embodiments, the offset is the difference in output of the turbidity sensor 250 in air as opposed to water at a particular temperature. For example, the output of the turbidity sensor 250 in air at one hundred degrees Fahrenheit may be four volts, while the output of the turbidity sensor 250 in the water at one hundred degrees Fahrenheit may be five volts, and, thus, the offset in the output of the turbidity sensor 250 between air and water may be one volt at one hundred degrees Fahrenheit. In step 440, such offset may be applied to the measurement output in order to compensate for the difference in output of the turbidity sensor 250 in water instead of air and at a particular temperature of the fluid. For example, the controller 137 may add or subtract the offset to/from the measurement output in order to determine the adjusted output. Thus, in the above example, the offset of one volt at one hundred degrees Fahrenheit may be subtracted from the output of the turbidity sensor exposed to a fluid at one hundred degrees Fahrenheit, seven volts, in order to determine an adjusted output of six volts. However, in alternative embodiments, the controller 137 may adjust the measurement output by the offset in any suitable manner in order to determine the adjusted output. Thus, it should be understood that other methods for adjusting the measurement output by the offset may be used and that the above method is only an example and is not intended to limit the scope of the present subject matter.

At step 450, the controller 137 may compare the turbidity of the fluid in the appliance to a predetermined value or threshold. The predetermined value might be, for example, a turbidity value that is 5%, 10%, 15%, or 20% greater or less than the turbidity of water. In exemplary embodiments, the controller 137 may compare the adjusted output to the predetermined value in order to determine if the turbidity of the fluid is greater than or less than the predetermined value. At step 450, at least in part in response to determining that the adjusted output is more or less than the predetermined value, the controller 137 may maintain a current cycle of the appliance and repeat steps 420-440. The controller 137 may maintain the current cycle of the appliance because when the turbidity of the fluid in the dishwasher is greater than or less than the predetermined value it may be inferred that a load in the appliance is not suitably clean.

At step 460, at least in part in response to determining that the turbidity of the fluid in the appliance is greater than or less than the predetermined value, the controller 137 may adjust the current cycle of the appliance. The controller 137 may adjust the current cycle of the appliance because if the turbidity of the fluid in the appliance is greater than or less than the predetermined value, then it may be inferred that the load in the appliance is suitably clean. Thus, at step 460, in exemplary embodiments, if the adjusted output is greater than or less than the predetermined value, the controller 137 may execute another step in a wash or rinse cycle such as draining water from the sump 150 and/or providing additional water into the appliance. Alternatively, in step 460, an adjustment to the cycle may be made such as e.g., to adjust a flow of a water supply 200 of the dishwasher 100, adjust a flow through the circulation pump assembly 172 of the dishwasher 100, and/or adjust the drain valve 186 and drain pump assembly 174 of the dishwasher 100 in order to begin draining a sump 150 of the dishwasher 100. Other actions after step 450 may be executed as well.

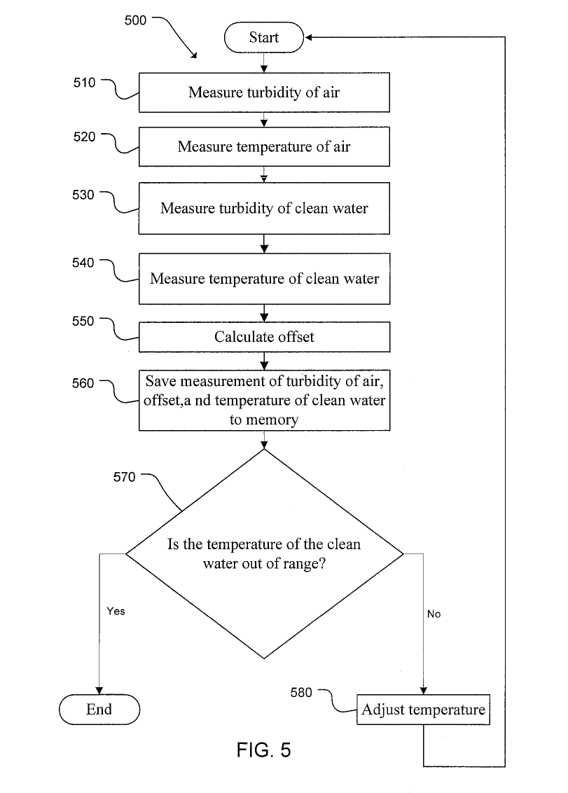

FIG. 5 provides a flow chart of exemplary method steps for calibrating a turbidity sensor 250. In this exemplary embodiment, the method 500 includes the following steps. Beginning at 510, a measurement of the turbidity of air is taken. The measurement may be taken with the turbidity sensor 250 when the turbidity sensor 250 is exposed to air. In exemplary embodiments, the measurement may be similar to the measurement taken in step 410 of the method described above.

At 520, the temperature of the air is measured. In exemplary embodiments, the temperature of the air may be determined, for example, using the temperature sensor 248 when the temperature sensor 248 is exposed to air.

At 530, a measurement of the turbidity of clean water is taken. The measurement of clean water may be taken when the turbidity sensor 250 is exposed to clean water. In exemplary embodiments, at 530, the turbidity sensor 250 may be exposed to water that is supplied to the dishwasher 100 from the water supply 200. In such exemplary embodiments, the water from the water supply 200 is assumed to be clean.

At 540, the temperature of the clean water is measured. In exemplary embodiments, the temperature of the clean water may be determined using, for example, the temperature sensor 248 when the temperature sensor 248 is exposed to the water from the water supply 200.

At 550, the offset between the output of the turbidity sensor 250 in air and clean water is determined. In exemplary embodiments, the offset is the difference in output of the turbidity sensor 250 in air as opposed to water at a particular temperature. For example, as described above, the output of the turbidity sensor 250 in air at one hundred degrees Fahrenheit may be four volts, while the output of the turbidity sensor 250 in the water at one hundred degrees Fahrenheit may be five volts, and, thus, the offset in the output of the turbidity sensor 250 between air and water may be one volt at one hundred degrees Fahrenheit.

At 560, the offset, measurements of the turbidity of air and clean water, and measurements of the temperature of air and clean water are saved. In alternative embodiments, any suitable combination of the measured values and offset may be saved. In exemplary embodiments, the controller 137 may be configured to store the values.

At 570, the measurement of the temperature of the clean water is compared to a range of temperatures in order to determine if the measured value is outside of the range of temperatures. Accordingly, in exemplary embodiments, at 570 if the measured temperature is inside of the range, the calibration is incomplete, and the method should be repeated in order to calculate further offsets between the output of the turbidity sensor 250 in air and clean water at the next incremental temperature as discussed below. However, in such embodiments, if the measured temperature is outside of the range, the calibration is complete, and the offsets may be stored by the controller for future use, for example, for use in the method shown in FIG. 4.

At 580, the temperature the clean water should be increased or decreased incrementally and offsets calculated at particular temperatures within a range of temperatures. Thus, for example, offsets should be calculated incrementally (e.g., every five, ten, or twenty degrees Fahrenheit) within ranges between about 50°, 60°, 70°, or 80° Fahrenheit to about 150°, 160°,170°,180°, or 190° Fahrenheit.

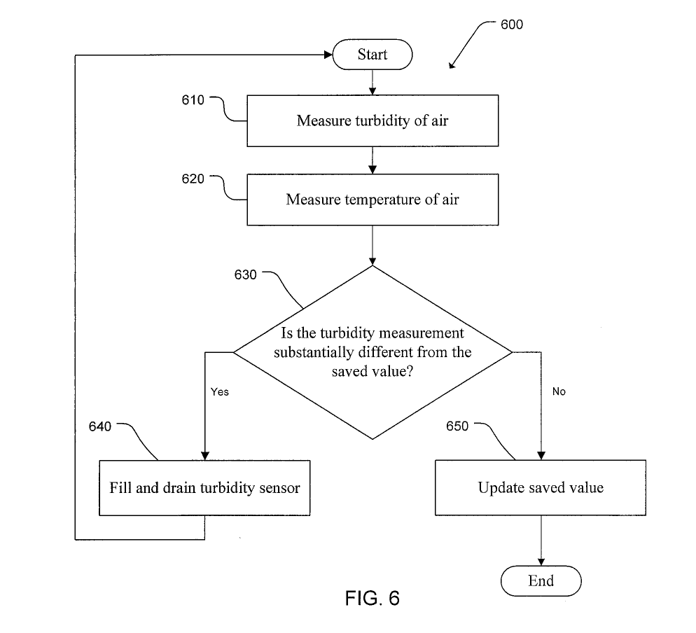

FIG. 6 provides a flow chart of exemplary method steps for updating a turbidity sensor calibration. In this exemplary embodiment, the method 600 includes the following steps. Beginning at 610, a measurement of the turbidity of air is taken. The measurement may be taken with the turbidity sensor 250 when the turbidity sensor 250 is exposed to air. In exemplary embodiments, the measurement may be similar to the measurement taken in step 410 of the method described above.

At 620, the temperature of the air is measured. In exemplary embodiments, the temperature of the air may be determined, for example, using the temperature sensor 248 when the temperature sensor 248 is exposed to air.

At 630, the measurement of the turbidity of the air and the measurement of the temperature of the air are compared to stored values of the turbidity of the air and the temperature of the air respectively. Comparison of the stored and measured values may be necessary to insure that the turbidity sensor 250 and the temperature sensor 248 are working properly. For example, the turbidity sensor 250 may include a plastic cover, and the physical properties of the plastic cover, e.g., the transmission coefficient, may change with time. In such example, the change in the physical properties may affect the output of the turbidity sensor 250 and thus the measurement of the turbidity of air. In exemplary embodiments, the stored values may be substantially different from the measured values if the stored values are five, ten, twenty, or thirty percent greater or less than the measured values.

In exemplary embodiments, at 630, the stored temperature of the air may not exactly match the measured temperature of the air. In such embodiments, an interpolated temperature may be substituted for the stored or measured value such that the interpolated temperature matches the one of the stored or measured temperature that was not substituted. In such embodiments, the respective one of the stored turbidity of air value and the measured turbidity of air value that corresponds to the temperature replaced by the interpolated temperature may also be interpolated. Thus, the interpolated turbidity of air value and the one of the stored turbidity of air value and the measured turbidity of air value that was not interpolated may be compared, and if the two are not substantially different, the stored value may be kept. Alternatively, if the two are substantially different, the stored values may be updated, for example, using the calibration method of FIG. 5 or by replacing the stored values with the measured values.

At 640, if the measured values are substantially different than the respective stored values, the controller 137 may fill and drain the dishwasher 100 in order to clean the turbidity sensor 250 and/or remove residual fluid.

At 650, if the measured values are not substantially different than the respective stored values, the stored values may be updated with the measured values, for example, the measured values may replace the stored values or if the stored values and the measured values are equal the stored values may be kept.

In additional exemplary embodiments, if the controller 137 has filled and drained the dishwasher 100 multiple times (e.g., three, four, or five or more times), and the output of the turbidity sensor 250 is still substantially different from the stored value. The method 600 may further comprise requesting a repair of the turbidity sensor 250. After multiple rinses, if the turbidity sensor 250 still has a substantially different output relative to the stored value it may be inferred that the turbidity sensor 250 is not working properly.

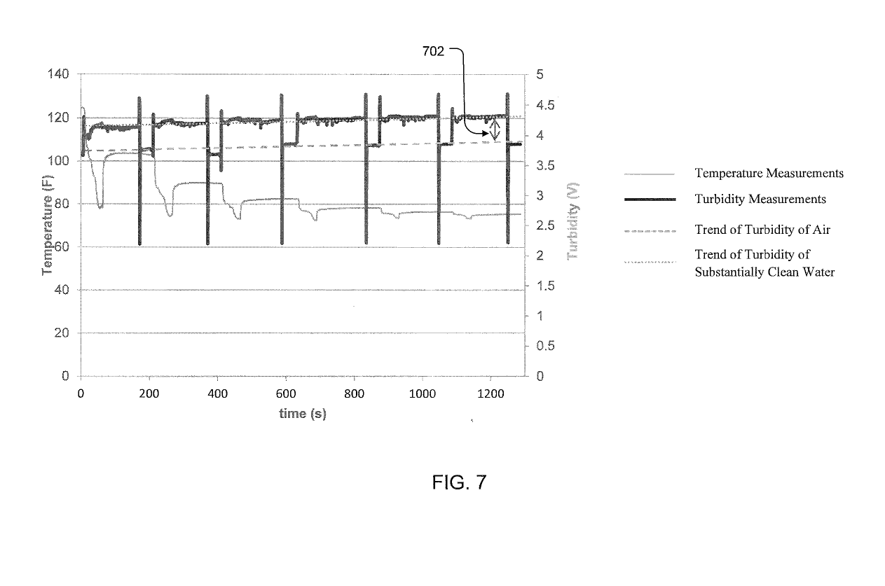

FIG. 7 depicts a graphical representation (e.g., a plot) of a series of turbidity sensor readings of water and air at various temperatures. Trends of the turbidity sensor readings in air and water are also shown in FIG. 5. In the illustrated embodiment, the trends may be used to determine the offset 702 between the turbidity sensor readings in air and water. As described above, the offset 702 may be a difference in the output of the turbidity sensor 250 between air and water at a particular temperature. As may be seen in FIG. 5, the offset 702 may be determined by comparing the trends of the outputs of the turbidity sensor 250 in air and water at a particular temperature. For example, as may be seen in the illustrated graphs, the turbidity sensor 250 has an offset 702 of about a half volt between water and air at about seventy-five degrees. It should be noted that, while the trends in the illustrated embodiment are substantially linear, in other embodiments the trends may be non-linear. In such other embodiments, the non-linear trends may be used in a similar fashion as the substantially linear trends of the illustrated embodiment in order to determine the offset. In alternative embodiments, the offset used by the controller 137 may be supplied by the manufacturer of the turbidity sensor 250. For example, the manufacturer of the turbidity sensor 250 may provide a table of offsets between air and water at particular temperatures.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a turbidity sensor; and
at least one processing device in communication with the turbidity sensor, wherein the at least one processing device is configured to:
conduct a measurement of turbidity with the turbidity sensor exposed to air instead of water so as to provide a reference output from the turbidity sensor exposed to air;
measure a turbidity of a fluid in the appliance during operation of the appliance with the turbidity sensor exposed to the fluid so as to provide a measurement output from the turbidity sensor exposed to the fluid;
determine a temperature of the fluid; and
apply an offset to the measurement output so as to provide an adjusted output, the offset compensating for the difference in output of the turbidity sensor in water instead of air and for the temperature of the fluid.

2. The appliance of claim 1, wherein the appliance is a dishwasher.

3. The appliance of claim 1, wherein the appliance is a washing machine.

4. The appliance of claim 1, wherein the processing device is configured to measure the turbidity of air when the appliance having the turbidity sensor is not being operated by a user.

5. The appliance of claim 1, wherein the processing device is configured to measure the turbidity of air at a time during operation of the appliance when the turbidity sensor is not exposed to a liquid.

6. The appliance of claim 1, wherein said time during operation when the turbidity sensor is not exposed to a liquid is a draining cycle or a drying cycle.

7. The appliance of claim 1, wherein the at least one processing device is further configured to compare the adjusted output to a predetermined value.

8. The appliance of claim 7, wherein the processing device is further configured to adjust a cycle of the appliance, based, at least in part, on whether adjusted output is less than the predetermined value.

9. The appliance of claim 1, wherein the processing device is further configured to determine the temperature of the fluid at about a time when the turbidity of the fluid is measured.

10. A method of performing a turbidity sensor reading for an appliance comprising the steps of:
conducting a measurement of turbidity with a turbidity sensor exposed to air instead of water so as to provide a reference output from the turbidity sensor exposed to air;
measuring a turbidity of a fluid in the appliance during operation of the appliance with the turbidity sensor exposed to the fluid so as to provide a measurement output from the turbidity sensor exposed to the fluid;
determining a temperature of the fluid; and
applying an offset to the measurement output from said step of measuring in order to provide an adjusted output, the offset compensating for the difference in output of the turbidity sensor in water instead of air and for the temperature of the fluid provided by said step of determining.

11. The method of claim 10, wherein the appliance is a dishwasher.

12. The method of claim 10, wherein the appliance is a washing machine.

13. The method of claim 10, wherein said step of conducting comprises measuring the turbidity of air when the appliance having the turbidity sensor is not being operated by a user.

14. The method of claim 10, wherein said step of conducting comprises measuring the turbidity of air at a time during operation of the appliance when the turbidity sensor is not exposed to a liquid.

15. The method of claim 14, wherein said time during operation is a draining cycle or a rinse cycle.

16. The method of claim 10, further comprising the step of obtaining the offset from a manufacturer of the turbidity sensor.

17. The method of claim 10, further comprising the step of comparing the adjusted output to a predetermined value.

18. The method of claim 17, further comprising the step of adjusting a cycle of the appliance based, at least in part, on whether the adjusted output is less than the predetermined value.

19. The method of claim 10, wherein said step of determining is performed at about a time of said step of measuring.
